(19) United States
(12) Patent Application Publication
(10) Pub. No.: US 2016/0034455 A1
(43) Pub. Date: Feb. 4, 2016

(54) MEDIA OBJECT MAPPING IN A MEDIA RECOMMENDER

(71) Applicant: Luma, LLC, St. Louis Park, MN (US)

(72) Inventors: James Musil, Minneapolis, MN (US); Aaron Weber, Orono, MN (US); Chris Miller, Saint Louis Park, MN (US); Ting Huang, Sammamish, WA (US); Robert Bodor, Plymouth, MN (US)

(21) Appl. No.: 14/879,455

(22) Filed: Oct. 9, 2015

Related U.S. Application Data
(63) Continuation-in-part of application No. 14/483,452, filed on Sep. 11, 2014.
Application No. 14/483,452 is a continuation-in-part of application No. 14/832,279, filed on Aug. 21, 2015.
Application No. 14/832,279 is a continuation-in-part of application No. 13/792,729, filed on Mar. 11, 2013, now abandoned.
Application No. 13/792,729 is a continuation-in-part of application No. 12/892,274, filed on Sep. 28, 2010, now Pat. No. 8,401,983.
Application No. 12/892,274 is a continuation-in-part of application No. 12/892,320, filed on Sep. 28, 2010, now Pat. No. 8,825,574.
Application No. 12/892,320 is a continuation-in-part of application No. 12/903,830, filed on Oct. 13, 2010.
(60) Provisional application No. 61/876,653, filed on Sep. 11, 2013.
(60) Provisional application No. 61/251,191, filed on Oct. 13, 2009.

(51) Int. Cl. G06F 17/30

(52) U.S. Cl. CPC G06F 17/30038; G06F 17/30542; G06F 17/30477; G06F 17/30554; G06F 17/30867

(57) ABSTRACT

A method of matching media objects comprises identifying an unknown media item as being the same media item as one of a plurality of known media items by comparing identifying information of the unknown media item with identifying information of one or more known media items. Comparing the identifying information comprises generating a match score for the unknown media item and at least one of the plurality of known media items by comparing the identifying information and determining that the media items match if the match score exceeds a fuzzy match threshold score. If the match score is below the fuzzy match threshold score but above a weak match threshold score, a crowdsource determination of whether the media items match is generated by receiving from two or more users a user determination of whether the media items match.

### CROSS-REFERENCE TO RELATED APPLICATIONS

This application is a continuation-in-part of U.S. patent application Ser. No. 14/483,452, filed on Sep. 11, 2014, which claims the benefit of U.S. Provisional Application No. 61/876,653, filed on Sep. 11, 2013. This application is also a continuation-in-part of U.S. patent application Ser. No. 14/832,279, filed on Aug. 21, 2015, which is a continuation-in-part of U.S. patent application Ser. No. 13/792,729, filed on Mar. 11, 2013, which is a continuation-in-part of U.S. patent application Ser. No. 12/892,274, now U.S. Pat. No. 8,401,983, filed on Sep. 28, 2010. The present application is further continuation-in-part of U.S. patent application Ser. No. 12/892,320, now U.S. Pat. No. 8,825,574, filed on Sep. 28, 2010. This application is further continuation-in-part of U.S. patent application Ser. No. 12/903,830, filed on Oct. 13, 2010, and which claims the priority of U.S. Provisional Application No. 61/251,191, filed on Oct. 13, 2009. All of the U.S. priority applications are herein incorporated by reference.

### FIELD

The invention relates generally to media item recommendation, and more specifically to media object mapping in a media recommender.

### BACKGROUND

The rapid growth of the Internet and the proliferation of inexpensive digital media devices have led to significant changes in the way media is bought and sold. Online vendors provide music, movies, and other media for sale on websites such as Amazon, for rent on websites such as Netflix, and available for person-to-person sale on websites such as EBay. The media is often distributed in a variety of formats, such as a movie available for purchase or rental on a DVD or Blu-Ray disc, for purchase and download, or for streaming delivery to a computer, media appliance, or mobile device.

Internet companies that provide media such as music, books, and movies derive profit from their sales, and it is in their best interest to sell customers multiple items or subscriptions to provide an ongoing stream of profits. Netflix, for example, provides a subscription service to customers enabling them to rent or stream movies, and profits as long as subscribers continue to find enough new movies to watch to remain a subscriber. Pandora provides streaming audio in a customized music station format based on a customer's music preferences, deriving profit from either subscriptions or from advertising placed in limited free services. Amazon derives the majority of its profits from sale of physical media, and increases its profit from providing a customer with media recommendations similar to items that a customer has already purchased.

Recommendations such as these are typically made by employing a recommendation engine to identify media that is similar to other media in which a customer has shown an interest, such as by purchasing, renting, or rating related media. Pandora, for example, uses an expert's characterization of a song using domain knowledge attributes such as structure, instrumentation, rhythm, and lyrical content to produce domain knowledge data for each song, and provides streaming songs matching identified customer preferences for one or more distinct customized stations based on its domain knowledge-based recommendation engine. Other media providers such as Netflix provide correlation-based recommendations, where user preferences for similar movies over a broad base of users and media are used to find preference correlation between the media and users in the database to recommend media correlated to other media a customer has liked.

Because the number of items purchased or the length of a subscription are related to the value a customer receives in continuing to interact with a media provider, it is in the provider's best interest to provide media recommendations that are accurate and well-tailored to its customers. It is therefore desirable to accurately identify and track a user's media preferences to provide the best quality media recommendations possible in a variety of media commerce environments.

### SUMMARY

One example embodiment of the invention comprises matching media objects by identifying an unknown media item as being the same media item as one of a plurality of known media items by comparing identifying information of the unknown media item with identifying information of one or more known media items. Comparing the identifying information comprises generating a match score for the unknown media item and at least one of the plurality of known media items by comparing the identifying information of the unknown media item with the identifying information of the one or more known media items, and determining that the unknown media item is the same media item as one of the plurality of known media items if the match score exceeds a fuzzy match threshold score. If the match score is below the fuzzy match threshold score but above a weak match threshold score, a crowdsource determination of whether the unknown media item is the same media item as one of the plurality of known media items is generated by receiving from two or more users a user determination of whether the unknown media item matches one of the plurality of known media items.

In another example, a method of identifying an unknown media item comprises comparing identifying information associated with the unknown media item with identifying information for a plurality of known media items using a weighted fuzzy match, such that strong weighted fuzzy matches between the unknown media item and one of the plurality of known media items are determined to be a match, weak fuzzy matches between the unknown media item and one of the plurality of known media items are determined not to be a match, and uncertain fuzzy matches are forwarded for user determination of whether the unknown media item matches one of the plurality of known media items.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a media recommendation system comprising a media object matching module, consistent with an example embodiment of the invention.

FIG. 2 shows matching an unknown media item to one of a plurality of known media items, consistent with an example embodiment of the invention.

FIG. 3 is a flowchart of a method of matching media objects, consistent with an example embodiment of the invention.

FIG. 4 is a computerized media recommendation system comprising an object mapping module, consistent with an example embodiment of the invention.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope the examples presented here. The following detailed description does not, therefore, limit the scope of what is claimed.

Recommendation of media such as books, movies, or music that a customer is likely to enjoy can improve the sales of online merchants such as Amazon, improve the subscription rate and duration of rental services such as Netflix, and help the utilization rate of advertising-driven services such as Pandora. Although revenue is derived from providing media in different ways in each of these examples, they all benefit from providing good quality recommendations to customers regarding potential media purchases, rentals, or other media use. Similarly, knowledge of a user's preferences and interests can help target advertising that is relevant to a particular user, such as advertising horror movies only to those who have shown an interest in honor films, targeting country music advertising toward those who prefer country to rap or pop music, and presenting book advertising to those who have shown a preference for similar books.

Media recommendations such as these are typically made by employing a recommendation engine to identify media that is similar to other media in which a customer has shown an interest, such as by purchasing, renting, or rating other similar media. Some websites, such as Netflix, ask a user to rank dozens of movies upon enrollment so that the recommendation engine can provide meaningful results. Other websites such as Amazon rely more upon a customer's purchase history and items viewed during shopping. Pandora differs from these approaches in that a user can rate relatively few pieces of media, and is provided a broad range of potentially similar media based on domain knowledge of the selected media items.

Because the number of items purchased or the length of a subscription are related to the value a customer receives in interacting with a media provider, it is in the provider's best interest to provide media recommendations that are accurate and well-suited to its customers. Poor recommendations may result in a user abandoning a service or merchant for another, while good recommendations will likely result in additional sales and profit. It is therefore desirable to accurately identify and track a user's media preferences to provide the best quality media recommendations possible.

This is achieved in one example by combining or compiling media recommendations from across multiple sites or services, such as using both a person's Netflix ratings and Amazon purchase history to generate more accurate ratings. But, combining user purchases, viewings, downloads, and ratings across multiple sites can be challenging in that sites may reference media items slightly differently, making recognition of media objects challenging.

For example, the movie “Superman” has been released several times as different movies, including a 1978 version starring Christopher Reeve, a 1952 version starring George Reeves, and a 2006 version starring Brandon Routh. In this example, it is desirable to treat the three different Superman movies as different media items because they feature different actors and plots, and are fundamentally different movies. Similarly, some media items are referenced using different names on different sites, such as “Star Wars Episdoe 2: Attack of the Clones” and “Star Wars Ep. II: The Attack of the Clones”. Because these differing titles refer to the same movie, having the same actors, plot, and film sequences, it is desirable to recognize that these somewhat different titles refer to the same movie.

Some example embodiments presented herein therefore match media objects using a matching system configured to handle such variations in media item identifying information. This is done in one example by identifying media item information for an unknown media object and one or more known media objects, and comparing the media item information of the unknown media object with identifying information of two or more known media objects to determine whether the unknown media object matches a known media object.

Media item information in movies, for example, might include in various embodiments movie title, actors, director, year of release, Motion Picture Association of America (MPAA) rating, UPC or ISBN code, and other such identifying information. The chance that an unknown media item matches a known media item is greater with more item information matches, and with stronger matches between item identifying information elements.

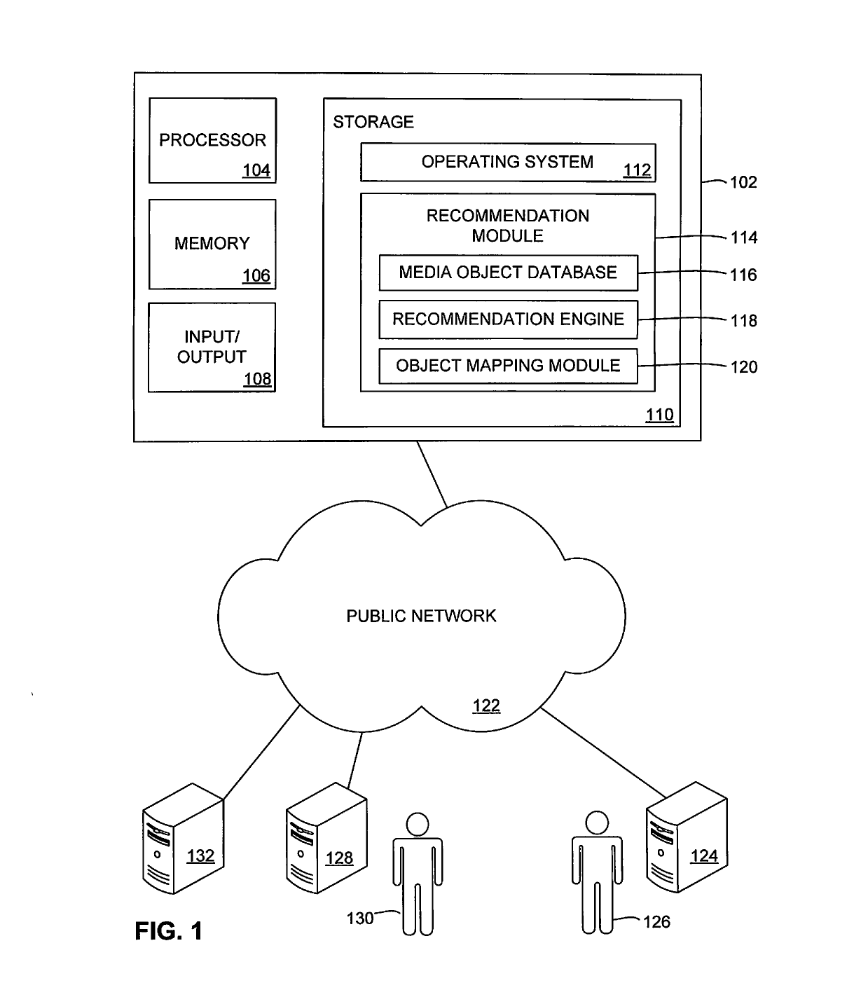

FIG. 1 shows a media recommendation system comprising a media object matching module, consistent with an example embodiment of the invention. Here, a media recommendation system 102 comprises a processor 104, memory 106, input/output elements 108, and storage 110. Storage 110 includes an operating system 112, and a recommendation module 114 that is operable to provide media item recommendations to a user. The recommendation module 114 further comprises a media object database 116, a recommendation engine 118, and an object matching module 120.

The media recommendation system 102 is connected to a public network 122, such as the Internet. Public network 122 serves to connect the media recommendation system media recommendation system 102 to remote computer systems, including user's computer 124 (associated with user 126), matching user computer 128 (associated with matching user 130), and reference data system 132.

In operation, the media recommendation system's processor executes program instructions loaded from storage 110 into memory 106, such as operating system 112 and recommendation module 114. The recommendation module includes software executable to provide media recommendations to user such as user 126, using recommendation engine 118 and media object database 116. The recommendation also includes media object mapping module 120, which is operable when executed to map unknown media objects to a known media object, facilitating use of media item data from multiple sources or in multiple formats in populating media object database 116 and in making media item recommendations using recommendation engine 118.

The media item recommendations generated by recommendation engine 118 are based in some examples upon media preference information for a user, such as information regarding a user's media purchases, ratings, and viewings, across multiple websites and services. To produce the most accurate media recommendations, media recommendation systems 102 gather information from across these websites and services to populate a media object database 116 containing the user's preferences. This information can then be used to generate recommendations for other media items, such as by using correlation-based recommendations, domain knowledge-based recommendations, or recommendations made using a combination of correlation-based and domain knowledge-based information.

Because not every website or merchant will refer to the same media item the same way, a media object mapping module 120 is used to determine what media references in the combined media object database are for the same media items, and what media references are for different media items. For example, when a new media item is found from a website or other merchant or service that has not yet been associated with a media item in the media object database 116, the new or unknown media object is compared to the media objects in the database to determine whether it is the same as any of the known media objects. This enables the media recommendation system to construct an accurate media object database 116 that includes media preference information from a variety of sources, such that the recommendation engine 118 can produce more accurate recommendations.

Object mapping module 120 in some examples matches media item information associated with the media items as identified by different preference sources, such as from different media services, retail websites, or rating and review sites. Media item information for movies includes in some examples movie title, actors, director, year of release, Motion Picture Association of America (MPAA) rating, UPC or ISBN code, and other such identifying information. In other examples, item information for items such as songs may include singer, album, and other such information, while item information for non-media items such as restaurants might include address, phone number, and other such identifying information. Object mapping module 120 is operable when executed to compare this item information of an unknown media item with known media items in media object database 116, and to determine whether the unknown media item matches a known media item or should be treated as a new media item.

In a more detailed example, a new media object imported into object database 116, such as a media object imported with user purchase, viewing, or rating information from another website or service, is matched against a database of known media objects, such as media objects previously rated by users or a standardized library of media objects. The unknown media object has identifying information, such as release year, title, actors, running time, etc., associated with the object, and this unknown media object information is compared against media object information for the known media objects. If an exact match between media object information is found, the unknown media object is identified as being the same as the matching known media object.

If no exact match is found, the information associated with the unknown media object is scored against known media objects having similar information using a weighted or fuzzy match. For example, a percentage match or score between all common identifying information is calculated in one example, while a percentage match or score between each common element of identifying information is calculated in another example. If the match score or percentage exceeds a certain threshold, the object mapping module 120 determines that the unknown media object matches the known media object. Similarly, if the match score or percentage is below a certain threshold, the object mapping module determines that the unknown media object is not a match with the known media object.

If the match score or percentage is within a certain range near a threshold, or is between a threshold for determining a match and a threshold for determining the items are not a match, the object mapping module determines in a further example that the items are a weak match. In one example, a fuzzy match threshold of 85% is set such that a match percentage above 85% indicates a match, while a weak match threshold of 70% is set such that a match percentage below 70% indicates the items are not a match. Scores between 70% and 85% are considered a weak match, and the object mapping module 120 forwards these weak matches for crowdsource mapping determination.

Crowdsource determination of object mapping or matching comprises in one example sending the pair of media items to a matching user 130 via public network 122 and patching user's computer 128, such that the matching user can view the pair of media items and make a determination as to whether they are the same media item. In a further example, user 130 is considered an expert, and the expert user's determination is considered an accurate indication of whether the items match and the match determination is stored in object database 116. In other examples, the user is a crowdsource or non-expert user, and a match determination is considered conclusive only if a certain percentage or number of crowdsource user determinations are the same.

In a more detailed example, a media item that fuzzy or weighted matching determines to be a weak match is forwarded to three matching users 130 for determination. If all three crowdsource users agree on whether the media objects match, the determination is considered conclusive. If one of the crowdsource match users disagrees with the other two match users, the media item is sent to an expert user for final match determination. Although this example uses only three crowdsource users to make a match determination, other examples may use fewer or more crowdsource match users, such as requiring that at least six of seven crowdsource match users agree on a match to avoid sending the match to an expert user for verification.

Media recommendation system 102's object mapping module 120 is further operable in some examples to verify a match by comparing the match against other services or websites matches for the same object. For example, an unknown media object imported from Netflix's database of a user's reviews may include an unknown media object, such as a new release or an obscure movie that is not yet in object database 116. If Netflix provides a “buy on Amazon now” button, a “read reviews on Rotten Tomatoes” button, or other link between the unknown media item and another database, the object mapping module can determine whether the linked media item on the associated websites is the same media item or is a recognized media item for confirmation of correct matching.

The unknown media objects are matched in some examples against an existing set of media objects built by the media recommendation system, such as may be stored in media object database 116. In other examples, a standardized set of media objects is used as a reference, such as the Tribune Media Services (TMS) database of television and movie data provided by reference data system 132. Use of a reference or standardized database may reduce the risk of duplicate media item entries and incomplete or inaccurate media item identifying information, and a TMS or other standardized database identifier may be incorporated into media item records stored in object database 116.

The media objects matched in the examples above illustrate matching a movie to a movie, but in other examples media objects such as songs, television shows, and the like are similarly matched. Different identifying information is employed for different media types, such that a television show may include identifying information such as season and episode number, and a song may include composer or album.

In still other examples, a media object such as a movie is matched to associated media or media information, such as matching a movie trailer to a movie, or a sample of a song to the song or album. Photos, play times, reviews, and other information commonly associated with media objects also can be matched to and associated with media objects using the methods and systems described herein.

Although the above examples illustrate matching media objects to other media objects, the methods and systems described can similarly be applied to other types of objects. For example, matching restaurants or other commercial establishments for review and recommendation may employ identifying information such as address, phone number, and other such information to match an unknown establishment against a database of known establishments, enabling compilation or combination of establishment information from multiple sources or services.

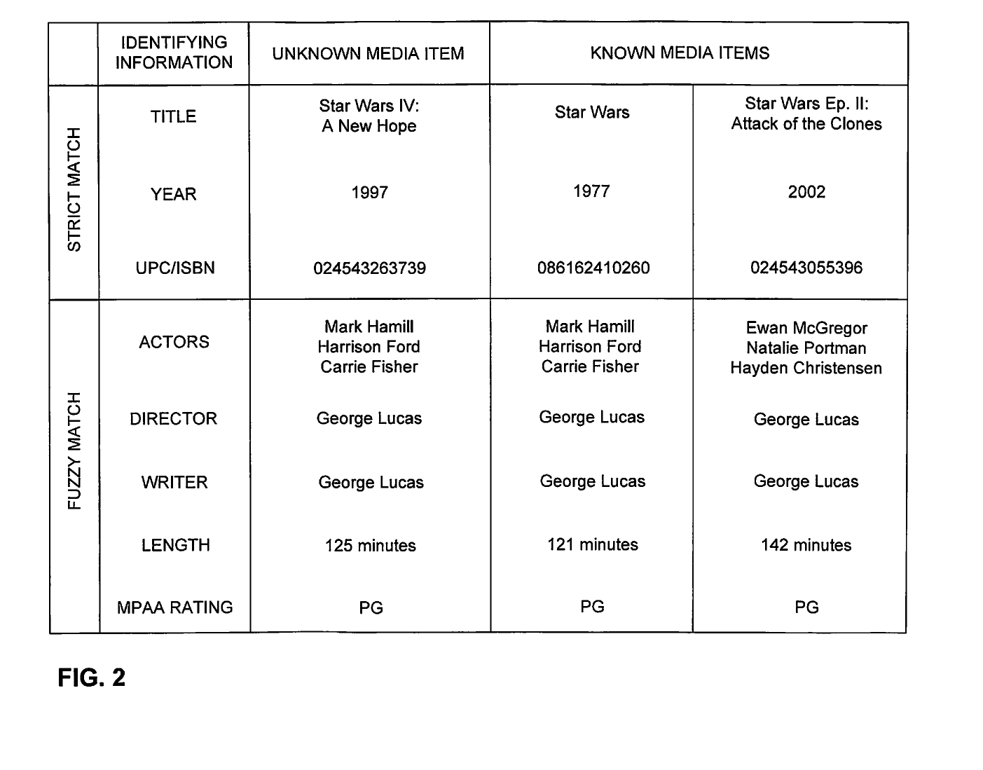

FIG. 2 shows matching an unknown media item to one of a plurality of known media items, consistent with an example embodiment of the invention. Here, an unknown media item titled “Star Wars IV: A New Hope” is compared against a database of known media items, including “Star Wars” and “Star Wars Ep. II: Attack of the Clones”. Because there is not a strict match between title, year, and UPC/ISBN number between the unknown media item and one of the known media items, the object mapping module 120 of FIG. 1 determines whether a fuzzy or weighted match exists.

The fuzzy match uses both the strict match and fuzzy match criteria to make a fuzzy match determination, recognizing that there is no exact match between title, year, or UPC/ISBN for the unknown media item. The actors in the unknown media item, however, are the same as the actors in “Star Wars”, and the director, writer, and MPAA rating of the unknown media item match both “Star Wars” and “Star Wars Ep. II: Attack of the Clones”. The length of the unknown media item does not match “Star Wars” or “Star Wars Ep. II: Attack of the Clones”, but the length is close to the length of “Star Wars” and may be considered a partial match. Similarly, the titles of all three movies contain the words “Star Wars” in the same order and adjacent to one another, and may be considered a partial match.

The unknown movie “Star Wars IV: A New Hope” in this example is therefore be considered a 70% match with “Star Wars” as 6 of 10 identifying information items match and two items partially match, and so it is considered a weak match. The unknown movie's match with “Star Wars Ep. II: Attack of the Clones” matches only 3 of 10 identifying information items with one partial match, and so it is considered a 35% match, or a poor match.

Because only a weak match has been identified, the movie “Star Wars IV: A New Hope” and the movie “Star Wars” are sent to crowdsource matching, where three matching users look at both media items and their associated identifying information and determine whether they are the same media item. Here, two of the crowdsource match users determine that they are the same movie, and therefore the same media item, while one crowdsource match user determines that the difference between movies in added material and edits is sufficient for the two movies to be considered different movies.

Because the three crowdsource matching users do not all agree on whether the unknown media item “Star Wars IV: A New Hope” is a match for “Star Wars”, the items are sent to an expert user for final determination of whether there is a match. Here, the expert user determines that although the differences between the original 1977 release and the revised 1997 release of the same movie are controversial, they are not substantial enough for the movies to be considered different movies, such that users will like one movie better than the other or otherwise consider them to be different movies, and so determines that the unknown media item is a match with “Star Wars”.

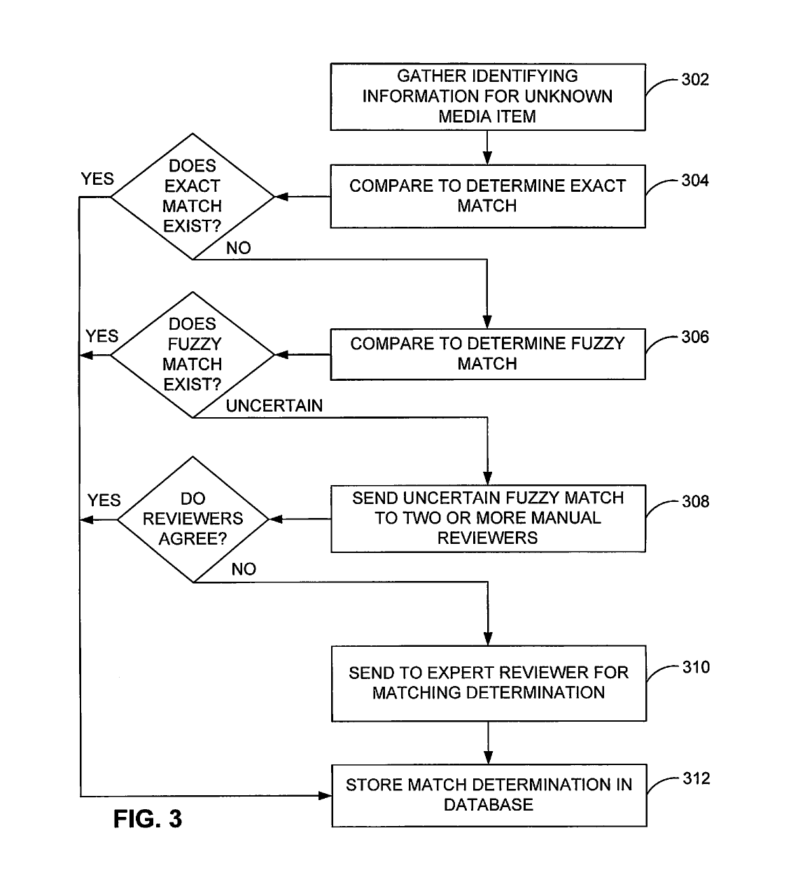

FIG. 3 is a flowchart of a method of matching media objects, consistent with an example embodiment of the invention. Here, rated items such as media are identified using identifying information likely to be common to the media object across multiple websites, such as a UPS code, ISBN number, or other such identifier. Returning to movies as an example, other item characteristics such as title, actors, release year, and the like are gathered at 302 to identify or confirm the identity of a particular movie. For example, simply searching for movies titled “Superman” yields a movie result, but examination of other criteria shows that separate versions were released in 1978 starring Christopher Reeve, in 1952 starring George Reeves, and in 2006 starring Brandon Routh. Examination of these characteristics enables the media recommendation system to distinguish between these three movies, and establish and track different ratings for each movie.

If an exact match between an unknown media item and a known media item is not found at 304, the media matching system uses a “fuzzy” or weighted system to determine whether two media items are the same or distinct, enabling the media rating system to account for minor variations in description of a movie. For example, “Star Wars Episode 2: Attack of the Clones” is clearly the same movie as “Star Wars Ep. II—The Attack of the Clones”, even though their titles vary somewhat. In this example, a fuzzy match can be estimated by comparing the titles, and the movies can be determined to be the same media by looking at secondary characteristics such as release date, actors, and the like. In a further embodiment, close or uncertain fuzzy matches at 306 can be flagged for user intervention, where user or administrator input can be used to determine whether two instances of a media item describe the same or different media items as shown at 308 and 310. This determination can then be stored at 312 and the item descriptions associated with one another, so that re-matching the same media descriptions to one another is not necessary.

Media matching can help determine whether media items having separate identities such as different UPC codes and slightly varying titles are different movies, for example, or are simply director's cuts, Blu-Ray and DVD versions, and other such versions of the same media item that should be treated as the same media item for purposes of rating. In this way, multiple media items from even a single source, such as Amazon, may be considered the same media item for purposes of rating and recommendation.

In a more detailed example, a media recommendation system such as 102 of FIG. 1 gathers identifying information for an unknown media item at 302, such as title, actors, director, run length, MPAA rating, and the like for movies, or series name, season, episode, year, guest stars, and the like for a television show. Object mapping module 120 of FIG. 1 compares the identifying information of the unknown media item with identifying information for known media items at 304, and determines whether an exact match exists. If an exact match exists between the unknown media item and one of the known media items, the match determination is stored in a database at 312.

If no exact match exists, the object mapping module 120 compares the identifying information of the unknown media item with identifying information of known media objects to determine whether a fuzzy match exists. If a fuzzy match exists, the match is stored in the database at 312, and if no match exists, the unknown media object is stored as a new media object, is stored for later matching, or is sent to an expert for review.

If an uncertain fuzzy match exists, the unknown media item and the known media item that is a fuzzy match are sent to two or more users for manual review at 308. If the two or more users agree, or agree to a certain threshold or percentage, the object mapping module 120 determines that the objects match and stores the match determination in database 312. If the reviewers do not agree, the media items are sent to an expert reviewer at 310 for final determination of whether the items match, and the match determination is stored in the database at 312.

If no match is found, the media items in a further example are stored for later matching, such as re-matching unmatched media items against new media items in the database or in a reference data set once per day, once per week, or the like. This facilitates rapid recognition of new media items, such as new movies or new television shows, without requiring user intervention. If an unknown media item does not match a known media item for a certain period of time, such as a month or a number of weeks, the media item may be added to the database as a new media item, or flagged for manual determination of how to handle the unknown media item. This provides for recognition of obscure or unusual media items not in a reference data set, or handling or correction of errors in a reference database of media items.

Mapping or matching unknown media objects to a data set of known media objects enables a media recommendation system 102 to compile media reviews, media purchases, media viewing history, and other media preference information from multiple sources to provide a better media recommendation to a user. This enables a media recommender to use knowledge of a user to provide the user with better advertising, recommendations, and other media tailored to the individual user. Advertisers rely on knowledge of a user to deliver advertising that fits a user's interests and preferences, just as media rental or sales companies such as Netflix and Amazon rely on knowledge of a customer's media preferences to recommend additional media for rental or purchase.

Recommendation of media such as books, movies, or music that a customer is likely to enjoy can improve the sales of websites such as Amazon, improve the subscription rate and duration of rental services such as Netflix, and help the utilization rate of advertising-driven services such as Pandora. Although each of these examples derive their revenue from providing media in different ways, they all benefit from providing good quality recommendations to customers regarding potential media purchases, rentals, or other use, and from deriving an accurate recommendation from a robust set of media preference information for each user. Similarly, knowledge of a user's preferences and interests can help target advertising that is relevant to a particular user, such as advertising horror movies only to those who have shown an interest in honor films, targeting country music advertising toward those who prefer country to rap or pop music, and presenting book advertising to those who have shown a preference for similar books.

Because a user typically interacts with media in a variety of environments, such as through advertising, through purchasing from sites such as Amazon, from renting via services such as Netflix, and from rating using sites like Flixster, an active online media consumer typically has created a significant amount of media preference information over time. But, because user preferences are often distributed over a large number of vendors, service providers, and ratings sites, the amount of created user preference information available to any specific provider or application can be greatly limited. It is therefore desirable to best make use of the variety of media preference information created by a user, to better perform tasks such as media recommendation and targeted advertising.

The media recommendation system 102 therefore combines user preference data from these multiple sources, creating a more robust data set for each user than may be available from any single source. But because, media items may be referenced somewhat differently in different data sets, as reflected in the examples presented herein, matching or mapping media items is employed to ensure that references to the same media item across different sites can be recognized.

The media recommendation system 102 in one example imports the media preference data from the selected third-party websites, and combines it with other media rating data in the user's media recommendation system account. By doing this, media preference information from a variety of sources can be added to media preference information generated directly on the media recommendation system website, and be used to provide better media recommendations to the user. The information in a further embodiment is provided to third party affiliates, such as sending the media data to Amazon so that it may make better movie purchase recommendations to the user, or to an advertising service such as Google Ads so that media advertising presented to the user is better tailored to the user's interests.

In a further embodiment, media recommendation system serves as a type of central arbiter or repository for ratings, such that when a user has elected to link various accounts such as Netflix or Rotten Tomatoes to the media recommendation system, the media recommendation system site receives media rating from a variety of other websites or services, consolidates the rating information, and distributes the consolidated information back out to one or more of the other websites or services. This enables third-party services such as Netflix or Amazon to benefit from media ratings originally provided on each others' sites, as well as benefitting from media ratings provided via other services such as Flixster.

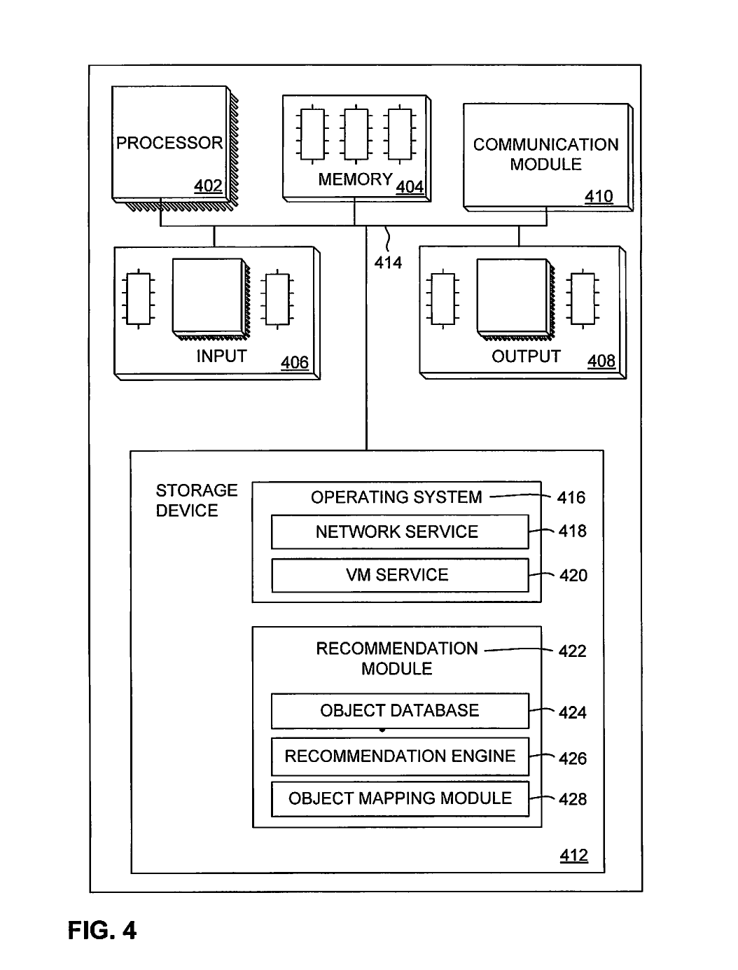

FIG. 4 is a computerized media recommendation system comprising an object mapping module, consistent with an example embodiment of the invention. FIG. 4 illustrates only one particular example of computing device 400, and other computing devices 400 may be used in other embodiments. Although computing device 400 is shown as a standalone computing device, computing devices 400 may be any component or system that includes one or more processors or another suitable computing environment for executing software instructions in other examples, and need not include one or more of the elements shown here.

As shown in the specific example of FIG. 4, computing device 400 includes one or more processors 402, memory 404, one or more input devices 406, one or more output devices 408, one or more communication modules 410, and one or more storage devices 412. Computing device 400, in one example, further includes an operating system 416 executable by computing device 400. The operating system includes in various examples services such as a network service 418 and a virtual machine service 420. One or more applications, such as recommendation module 422 are also stored on storage device 412, and are executable by computing device 400. Each of components 402, 404, 406, 408, 410, and 412 may be interconnected (physically, communicatively, and/or operatively) for inter-component communications, such as via one or more communications channels 414. In some examples, communication channels 414 include a system bus, network connection, interprocessor communication network, or any other channel for communicating data. Applications such as recommendation module 422 and operating system 416 may also communicate information with one another as well as with other components in computing device 400.

Processors 402, in one example, are configured to implement functionality and/or process instructions for execution within computing device 400. For example, processors 402 may be capable of processing instructions stored in storage device 412 or memory 404. Examples of processors 402 include any one or more of a microprocessor, a controller, a digital signal processor (DSP), an application specific integrated circuit (ASIC), a field-programmable gate array (FPGA), or similar discrete or integrated logic circuitry.

One or more storage devices 412 may be configured to store information within computing device 400 during operation. Storage device 412, in some examples, is described as a computer-readable storage medium. In some examples, storage device 412 comprises temporary memory, meaning that a primary purpose of storage device 412 is not long-term storage. Storage device 412, in some examples, is described as a volatile memory, meaning that storage device 412 does not maintain stored contents when computing device 400 is turned off. In other examples, data is loaded from storage device 412 into memory 404 during operation. Examples of volatile memories include random access memories (RAM), dynamic random access memories (DRAM), static random access memories (SRAM), and other forms of volatile memories known in the art. In some examples, storage device 412 is used to store program instructions for execution by processors 402. Storage device 412 and memory 404, in various examples, are used by software or applications running on computing device 400 such as recommendation module 422 to temporarily store information during program execution.

Storage device 412, in some examples, includes one or more computer-readable storage media that may be configured to store larger amounts of information than volatile memory. Storage device 412 may further be configured for long-term storage of information. In some examples, storage devices 412 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 400, in some examples, also includes one or more communication modules 410. Computing device 400 in one example uses communication module 410 to communicate with external devices via one or more networks, such as one or more wireless networks. Communication module 410 may be a network interface card, such as an Ethernet card, an optical transceiver, a radio frequency transceiver, or any other type of device that can send and/or receive information. Other examples of such network interfaces include Bluetooth, 3G or 4G, WiFi radios, and Near-Field Communication s (NFC), and Universal Serial Bus (USB). In some examples, computing device 400 uses communication module 410 to wirelessly communicate with an external device such as via public network 122 of FIG. 1.

Computing device 400 also includes in one example one or more input devices 406. Input device 406, in some examples, is configured to receive input from a user through tactile, audio, or video input. Examples of input device 406 include a touchscreen display, a mouse, a keyboard, a voice responsive system, video camera, microphone or any other type of device for detecting input from a user.

One or more output devices 408 may also be included in computing device 400. Output device 408, in some examples, is configured to provide output to a user using tactile, audio, or video stimuli. Output device 408, in one example, includes a display, a sound card, a video graphics adapter card, or any other type of device for converting a signal into an appropriate form understandable to humans or machines. Additional examples of output device 408 include a speaker, a light-emitting diode (LED) display, a liquid crystal display (LCD), or any other type of device that can generate output to a user.

Computing device 400 may include operating system 416. Operating system 416, in some examples, controls the operation of components of computing device 400, and provides an interface from various applications such as recommendation module 422 to components of computing device 400. For example, operating system 416, in one example, facilitates the communication of various applications such as recommendation module 422 with processors 402, communication unit 410, storage device 412, input device 406, and output device 408. Applications such as recommendation module 422 may include program instructions and/or data that are executable by computing device 400. As one example, recommendation module 422 and its object database 424, recommendation engine 426, and object mapping module 428 may include instructions that cause computing device 400 to perform one or more of the operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of matching media objects, comprising:
determining identifying information associated with an unknown media item;
determining identifying information associated with a plurality of known media items;
identifying the unknown media item as being the same media item as one of the plurality of known media items by comparing the identifying information of the unknown media item with the identifying information of one or more known media items, such that comparing the identifying information comprises:
generating a match score for the unknown media item and at least one of the plurality of known media items by comparing the identifying information of the unknown media item with the identifying information of the one or more known media items, and determining that the unknown media item is the same media item as one of the plurality of known media items if the match score exceeds a fuzzy match threshold score; and
if the match score is below the fuzzy match threshold score but above a weak match threshold score, generating a crowdsource determination of whether the unknown media item is the same media item as one of the plurality of known media items by receiving from two or more users a user determination of whether the unknown media item matches one of the plurality of known media items.

2. The method of matching media objects of claim 1, wherein comparing the identifying information further comprises comparing the identifying information of the unknown media item with the identifying information of the one or more known media items to determine whether there is an exact match between the unknown media item and one of the one or more known media items, and generating a match score only if there is not an exact match.

3. The method of matching media objects of claim 1, wherein generating a crowdsource determination of whether the unknown media item is the same media item as one of the plurality of known media items further comprises determining that the unknown media item matches one of the plurality of known media items if a crowdsource match threshold percentage of the two or more user determinations indicate that the unknown media item and one of the plurality of known media items match.

4. The method of matching media objects of claim 3, wherein inconclusive crowdsource determinations having a percentage of crowdsource determinations indicating a match between the crowdsource match threshold percentage and a crowdsource no-match threshold percentage are forwarded to an expert for expert determination of whether the unknown media item matches one of the plurality of known media items.

5. The method of matching media objects of claim 1, wherein identifying information comprises one or more of title, actors, singers, release year, director, length, UPC code, and ISBN number.

6. The method of matching media objects of claim 1, wherein at least one of the matched media items comprises an associated media item comprising one or more of a trailer, a sample, photo, play times, and reviews.

7. The method of matching media objects of claim 1, further comprising confirming the matched media items by determining how others have mapped the same unknown media item.

8. The method of matching media objects of claim 1, wherein at least one of the matched media items comprises a media item in a reference data set.

9. The method of matching media objects of claim 1, further comprising scheduling periodic retries if no match is found for an unknown media item.

10. The method of matching media objects of claim 1, further comprising manual verification of a match if a user flags a match as inaccurate.

11. A media object matching system, comprising:
a processor; and
a media object matching module comprising instructions executable on the processor and operable to identify an unknown media item having associated identifying information as being the same media item as one of a plurality of known media items having associated identifying information by comparing the identifying information of the unknown media item with the identifying information of one or more known media items, such that comparing the identifying information comprises:
generating a match score for the unknown media item and at least one of the plurality of known media items by comparing the identifying information of the unknown media item with the identifying information of the one or more known media items, and determining that the unknown media item is the same media item as one of the plurality of known media items if the match score exceeds a fuzzy match threshold score; and
if the match score is below the fuzzy match threshold score but above a weak match threshold score, generating a crowdsource determination of whether the unknown media item is the same media item as one of the plurality of known media items by receiving from two or more users a user determination of whether the unknown media item matches one of the plurality of known media items.

12. The media object matching system of claim 11, wherein comparing the identifying information further comprises comparing the identifying information of the unknown media item with the identifying information of the one or more known media items to determine whether there is an exact match between the unknown media item and one of the one or more known media items, and generating a match score only if there is not an exact match.

13. The media object matching system of claim 11, wherein generating a crowdsource determination of whether the unknown media item is the same media item as one of the plurality of known media items further comprises determining that the unknown media item matches one of the plurality of known media items if a crowdsource match threshold percentage of the two or more user determinations indicate that the unknown media item and one of the plurality of known media items match.

14. The media object matching system of claim 13, wherein the media object matching module is further operable to forward inconclusive crowdsource determinations having a percentage of crowdsource determinations indicating a match between the crowdsource match threshold percentage and a crowdsource no-match threshold percentage to an expert for expert determination of whether the unknown media item matches one of the plurality of known media items.

15. The media object matching system of claim 11, wherein identifying information comprises one or more of title, actors, singers, release year, director, length, UPC code, and ISBN number.

16. The media object matching system of claim 11, wherein at least one of the matched media items comprises an associated media item comprising one or more of a trailer, a sample, photo, play times, and reviews.

17. A method of identifying an unknown media item, comprising:
comparing identifying information associated with the unknown media item with identifying information for a plurality of known media items using a weighted fuzzy match, such that strong weighted fuzzy matches between the unknown media item and one of the plurality of known media items are determined to be a match, weak fuzzy matches between the unknown media item and one of the plurality of known media items are determined not to be a match, and uncertain fuzzy matches are forwarded for user determination of whether the unknown media item matches one of the plurality of known media items.

18. The method of identifying an unknown media item of claim 17, wherein the identifying information comprises one or more of media item title, release date, actor, UPC, and ISBN.

19. The method of identifying an unknown media item of claim 17, wherein the same media item in different formats are considered a match.

20. The method of identifying an unknown media item of claim 17, further comprising associating information associated with an unknown media item matched with a known media item with the known media item, facilitating more accurate future recognition of the same media item.
